(19) United States
(12) Patent Application Publication
(10) Pub. No.: US 2011/0231160 A1
(43) Pub. Date: Sep. 22, 2011

(54) SUBJECT INFORMATION PROCESSING APPARATUS, SUBJECT INFORMATION PROCESSING METHOD, AND SUBJECT INFORMATION PROCESSING PROGRAM

(75) Inventor: Koichi Suzuki, Kodaira-shi (JP)

(73) Assignee: CANON KABUSHIKI KAISHA, Tokyo (JP)

(21) Appl. No.: 13/046,999

(22) Filed: Mar. 14, 2011

(30) Foreign Application Priority Data
Mar. 17, 2010 (JP) 2010-060884

(51) Int. Cl. G06F 19/00

(52) U.S. Cl. 702/189

(57) ABSTRACT

Provided is a technology for improving accuracy of noise elimination by a wavelet transform. The present invention is a subject information processing apparatus including: an acoustic wave generator which generates an acoustic wave from a subject; a probe which receives the acoustic wave and converts the received acoustic wave into an electric signal; a converting processor which determines a wavelet coefficient string by performing the wavelet transform on the electric signal; and a threshold processor which eliminates wavelet coefficients smaller than a predetermined threshold out of the wavelet coefficient string, wherein the converting processor selects a coefficient string corresponding to a mother wavelet of which degree of similarity with an impulse response waveform of the probe is highest, out of coefficient strings corresponding to a plurality of mother wavelets stored in advance, and performs the wavelet transform.

### BACKGROUND OF THE INVENTION

1. Field of the Invention

The present invention relates to a subject information processing apparatus, a subject information processing method and a subject information processing program for receiving acoustic waves emitted from a subject.

2. Description of the Related Art

A lot of research has been ongoing in medical fields related to technologies for imaging a form and function of internal tissues by irradiating an acoustic wave, pulse laser beam or the like, onto a subject, which is a measuring object, and receiving and processing acoustic waves emitted from inside the measuring object. For example, there is an apparatus using an ultrasonic echo technology which irradiates an ultrasonic wave, which is an acoustic wave, onto a biological tissue, and receives the reflected ultrasonic wave (acoustic wave). There is also an apparatus using photoacoustic tomography (PAT), which irradiates light onto a biological tissue, and receives a photoacoustic wave which is generated by the expansion/contraction of the biological tissue which absorbed the light. In the conventional biological information processing apparatuses using such technologies, an acoustic wave emitted from the biological tissue is converted into electric signals using a probe where electro-acoustic converting elements are integrated. Then signal processing is performed on the electric signals so as to obtain images representing the form and function inside the biological tissue.

In the electric signals obtained from a probe, not only the signals generated from an acoustic wave emitted from a measuring object, but also noise propagating electric circuits and cables, mix. In order to obtain good quality diagnostic images, this noise must be decreased, so noise reduction processing using frequency conversion, represented by a wavelet transform, is widely used.

An available reference document is, for example, Sergey A. Ermilov, Reda Gharieb, Andre Conjusteau, Tom Miller, Ketan Mehta, and Alexander A. Oraevsky, “Data Processing and quasi-3D optoacoustic imaging of tumors in the breast using a linear arc-shaped array of ultrasonic transducers”, Proc. of SPIE Vol. 6856.

According to this document, a part of wavelet coefficients is eliminated after wavelet transform processing is performed on the received electric signals. Then an inverse wavelet transform is performed, whereby noise mixed in the electric signals is efficiently reduced, and diagnostic image quality improves.

Various types of wavelet transforms have been proposed depending on the function to be used for the base. Typically Daubechies, Symlet and Coiflet wavelets are well known. A function to be used as the base of the wavelet transform is called a “mother wavelet”. Depending on the type of the wavelet transform, the wavelet coefficient distribution is different. Therefore in the noise reduction processing, it is important to use a type of wavelet transform which can nicely separate signal components generated from an acoustic wave emitted from a measuring object, and the noise components generated from an area other than the measuring object.

According to above described reference document, noise is separated by using the wavelet transform of which mother wavelet is a cubic Gaussian function similar to a theoretically determined signal waveform.

### SUMMARY OF THE INVENTION

In the case of conventional wavelet transform processing, wavelet transform, of which mother wavelet is a function similar to a theoretically determined signal waveform under ideal conditions is performed. Actually however, the frequency bands of a probe are finite, so the waveform of the electric signal which was converted and output by the probe is different from an ideal waveform. If the wavelet transform, of which mother wavelet is based on the signal waveform under ideal conditions, is performed on this signal waveform, a part of the signal components may be lost by noise elimination because the signal components and noise components cannot be seperated well. As a result, a pathologically changed area may not be detected in the diagnostic image, or an artifact may be generated. If the noise elimination intensity is weakened to prevent the generation of such a side effect, weak signals generated from a pathologically changed area deep in the measuring object may be obscured by the noise, which makes the area invisible in the diagnostic image.

With the foregoing in view, it is an object of the present invention to provide a technology to improve the accuracy of noise elimination based on a wavelet transform.

This invention provides a subject information processing apparatus, comprising:

an acoustic wave generator which generates an acoustic wave from a subject;

a probe which receives the acoustic wave generated from the subject, and converts the received acoustic wave into an electric signal;

a converting processor which determines a wavelet coefficient string by performing a wavelet transform on the electric signal; and

a threshold processor which eliminates wavelet coefficients smaller than a predetermined threshold, out of the wavelet coefficient string, wherein

the converting processor selects a coefficient string corresponding to a mother wavelet of which degree of similarity with an impulse response waveform of the probe is highest, out of coefficient strings corresponding to a plurality of mother wavelets stored in advance, and performs the wavelet transform.

This invention further provides a subject information processing method, comprising:

a step of an information processing apparatus converting an acoustic wave, which is generated from a subject and received by a probe, into an electric signal;

a converting step of the information processing apparatus determining a wavelet coefficient string by performing a wavelet transform on the electric signal; and

a step of the information processing apparatus eliminating wavelet coefficients smaller than a predetermined threshold out of the wavelet coefficient string, wherein

in the converting step, a coefficient string corresponding to a mother wavelet of which degree of similarity with an impulse response waveform of the probe is highest is selected out of coefficient strings corresponding to a plurality of mother wavelets stored in advance, and the wavelet transform is performed.

This invention further provides subject information processing program causing an information processing apparatus to execute:

a converting step of determining a wavelet coefficient string by performing a wavelet transform on an electric signal converted from an acoustic wave which is generated from a subject and received by a probe; and

a step of eliminating wavelet coefficients smaller than a predetermined threshold out of the wavelet coefficient string, wherein

in the converting step, a coefficient string corresponding to a mother wavelet of which degree of similarity with an impulse response waveform of the probe is highest is selected out of coefficient strings corresponding to a plurality of mother wavelets stored in advance, and the wavelet transform is performed.

According to the present invention, the accuracy of noise elimination based on a wavelet transform can be improved.

Further features of the present invention will become apparent from the following description of exemplary embodiments with reference to the attached drawings.

### BRIEF DESCRIPTION OF THE DRAWINGS

FIG. 1 is a block diagram depicting a biological information processing apparatus of Example 1;

FIG. 2 is a flow chart depicting a general processing according to Example 1;

FIG. 3 is a diagram depicting an internal configuration of a converting parameter calculator according to Example 1;

FIG. 4 is a flow chart depicting a processing of the converting parameter calculator;

FIG. 5 shows an example of correspondence stored in a filter coefficient memory;

FIG. 6 is an internal circuit diagram of a converting processor;

FIG. 7 is a diagram depicting an internal configuration of a converting parameter calculator according to Example 2;

FIG. 8 shows an example of correspondence stored in an ID-filter correspondence memory;

FIG. 9 is a block diagram depicting a biological information processing apparatus of Example 3;

FIG. 10 is a flow chart depicting a general processing according to Example 3;

FIG. 11 is a block diagram depicting a biological information processing apparatus of Example 4; and

FIG. 12 is a flow chart depicting a general processing according to Example 4.

### DESCRIPTION OF THE EMBODIMENTS

Embodiments of the present invention will now be described with reference to the drawings. In the following example, a biological information processing apparatus which uses a part of a biological tissue as a subject will be described as an example of a subject information processing apparatus.

### Example 1

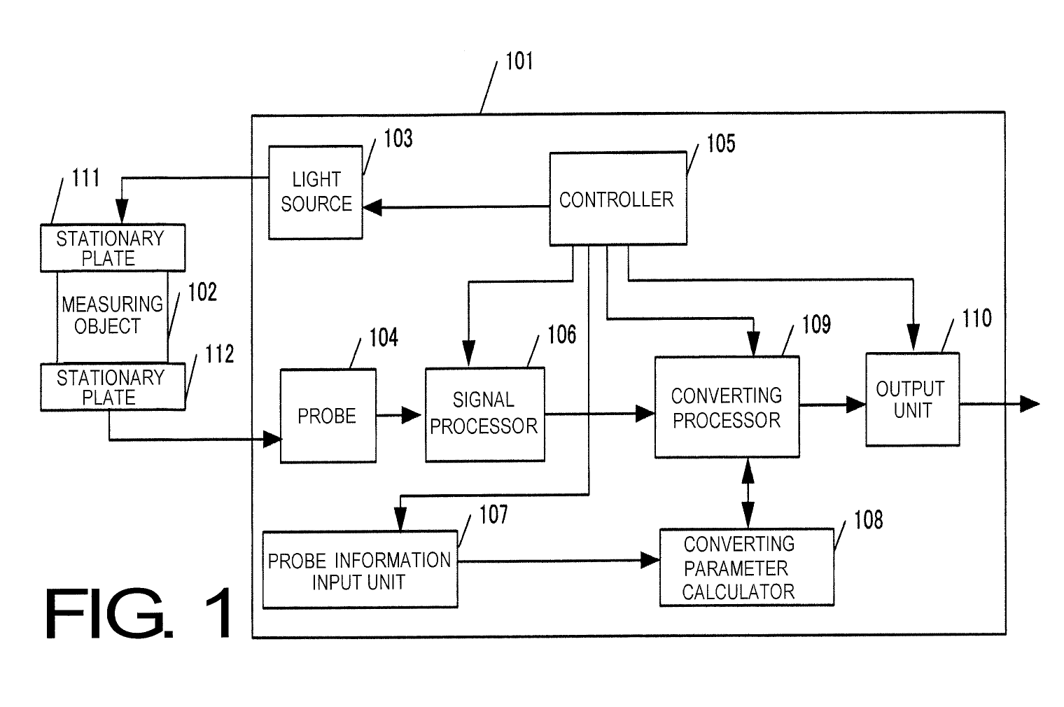

FIG. 1 is a block diagram depicting a biological information processing apparatus 101 of Example 1. The biological information processing apparatus of Example 1 uses a photoacoustic tomography technology. In FIG. 1, a measuring object 102 is an object to be measured, and is a part of a body of a subject person, for example. The measuring object 102 is a subject of the present invention. A light source 103 is a pulse laser light source for generating a photoacoustic wave from the measuring object 102. The light source 103 corresponds to an acoustic wave generator. A probe 104 is a transducer which converts a photoacoustic wave generated from the measuring object 102 into an electric signal, and a controller 105 controls operation timing of each block.

A signal processor 106 is an electric circuit which receives and processes an electric signal from the probe 104, and inputs the processed electric signal into a converting processor 109, and is comprised of an application circuit and A/D conversion circuit, among others. A probe information input unit 107 is an input unit which stores characteristic information of the probe 104, and inputs the characteristic information to a converting parameter calculator 108. The converting parameter calculator 108 is a digital circuit for calculating a converting parameter.

A converting processor 109 is a circuit which performs discrete wavelet transform on data input from the signal processor 106 and the probe information input unit 107. An output unit 110 is an interface circuit which outputs wavelet-transformed data to the outside. The output data is converted into an image by an imaging unit, such as an externally connected personal computer, and is displayed on the display screen. The output unit 110 corresponds to the threshold processing unit. Stationary plates 111 and 112 are plate members for securing the measuring object 102. The stationary plate 112 is constituted by a material where an acoustic wave easily propagates.

In the discrete wavelet transform performed by the converting processor 109, a high pass filter and low pass filter are repeatedly used for input signals to separate bands. A band separated wavelet coefficient string is output to the output unit 110. It is assumed that coefficients of the high pass filter and low pass filter are calculated as converting parameters by the converting parameter calculator 108, and are then input.

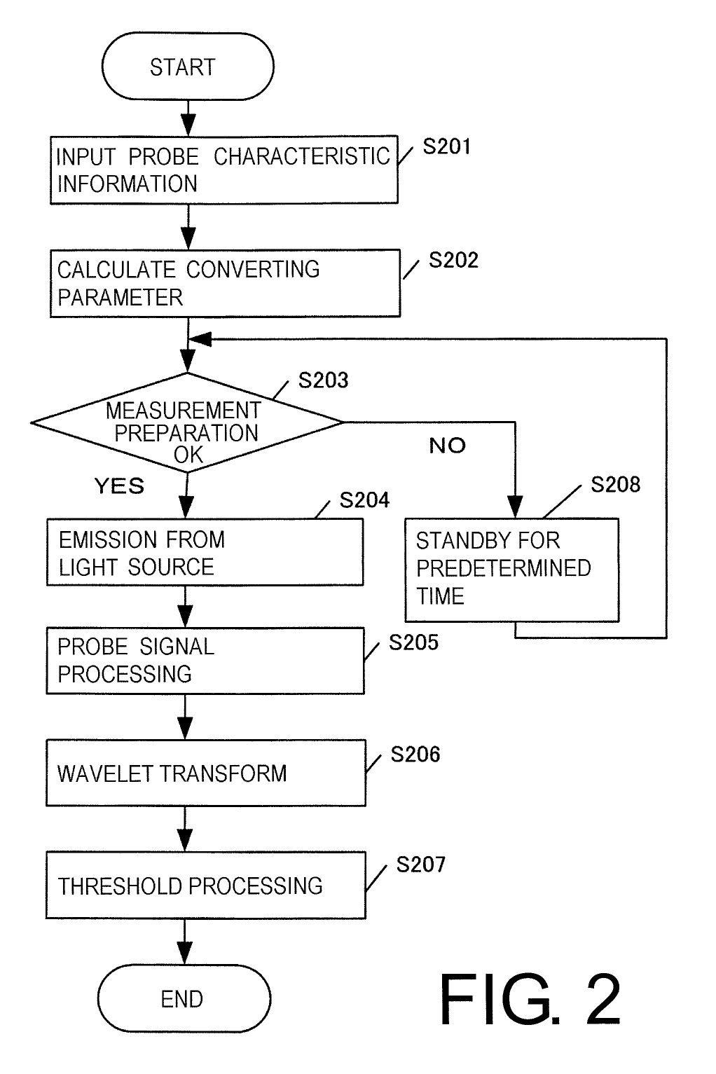

FIG. 2 shows a general processing flow of this example.

In step S201, the probe information input unit 107 inputs probe characteristic information to the converting parameter calculator 108. In this example, impulse response waveform data of the probe is input as the probe characteristic information. The impulse response waveform is an output signal of the probe for a very short acoustic wave. The impulse response waveform is an output waveform for a most fundamental input, and the output signal from the probe 104 has a waveform close to superposed impulse responses. For example, the impulse response waveform data can be stored in an external storage device, which is not illustrated, and obtained according to the type of probe.

In step S202, the converting parameter calculator 108 selects a filter coefficient corresponding to a type of wavelet transform to be used for the converting processor 109, as a converting parameter. Out of the filter coefficient candidates which are provided in advance, one having the highest performance to separate the signal components and noise components is selected by a later mentioned method. At this time, a wavelet transform is attempted using the filter coefficient candidates for an impulse response waveform of the probe which was input in step S201, and a filter coefficient which has the highest performance to separate the signal components and noise components is selected.

In step S203, the controller checks if measurement preparation is ready. If the measuring object 102 is secured in the front of the probe 104 and the light source 103 by the stationary plates 111 and 112, the controller determines that measurement preparation is ready, and processing advances to step S204. If measurement preparation is not ready, processing advances to step S208, stands by for a predetermined time, then returns to step S203.

In step S204, the controller 105 instructs the light source 103 to irradiate the pulse laser beam onto the measuring object 102. If the pulse laser beam is irradiated onto the measurement object 102, a photoacoustic wave according to the internal tissue state is generated, and is converted into an electric signal by the probe 104.

In step S205, the signal processor 106 amplifies and digitizes the electric signal, and inputs the result into the converting processor 109.

In step S206, the converting processor 109 performs wavelet transform. At this time, the converting processor 109 performs wavelet transform processing on the signal digitized in step S206, using a filter coefficient calculated in step S202 to calculate the wavelet coefficient string.

In step S207, the output unit 110 changes coefficients less than or equal to a predetermined threshold to 0, and outputs the result.

In the processing in step S202, a filter coefficient of which performance, to separate the signal components and noise component for the impulse response waveform of an actually used probe 104, is high is selected. Therefore in the wavelet transform in step S206, the signal components generated from the photoacoustic wave of the measuring object 102 and irregular noise components can be accurately separated. As a result, the signal components appear in a few coefficients as large values, and irregular noise components are distributed in many coefficients as small values. By the processing in step S207, noise components distributed as smaller values than the threshold are eliminated, and only signal components generated from the photoacoustic wave are output.

Now a method of selecting a filter coefficient in step S202 will be described with reference to the drawings.

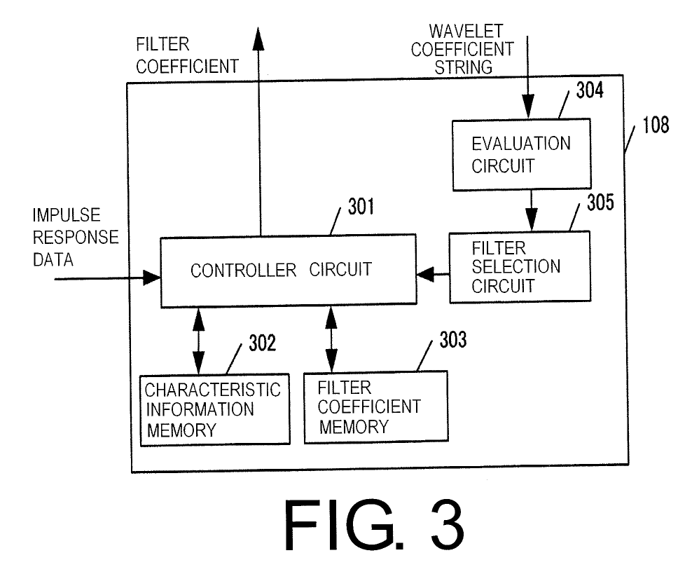

FIG. 3 is a diagram depicting an internal configuration of the converting parameter calculator 108. A controller circuit 301 is a circuit which accesses an internal memory, and transfers data to the converting processor 109. A characteristic information memory 302 is a memory for temporarily holding information which is input from the probe information input unit 107. A filter coefficient memory 303 is a memory which holds filter coefficients corresponding to various wavelets.

For a type of wavelet transform, such known wavelet transforms as Daubechies, Symlet and Coiflet can be used. In a wavelet transform, a mother wavelet, which is associated with a natural number N, is used, and smoothness increases as N increases. Hereafter a type of wavelet transform is represented by a combination of the type of function and the natural number N. For example, Daubechies4 means that wavelet type Daubechies of which the natural number to indicate smoothness is 4.

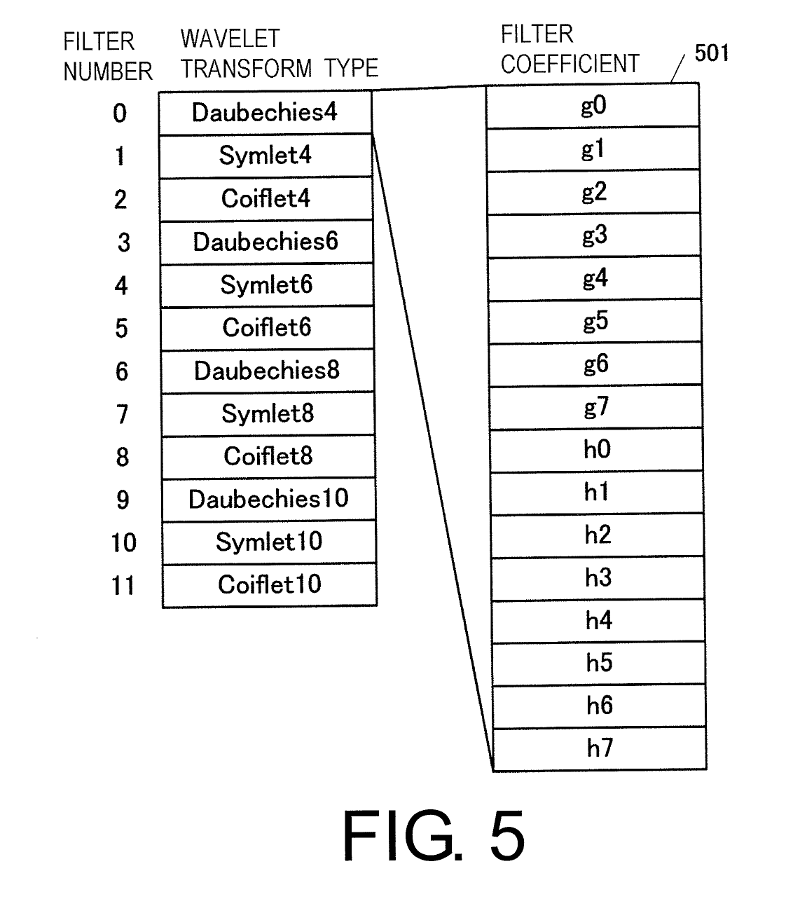

FIG. 5 shows an example of correspondence of a number and name of wavelets held in the filter coefficient memory 303, and filter coefficients 501 stored in the filter coefficient memory. For example, NO. 0 is a wavelet Daubechies4, and values g0 to g7, as coefficients of a low pass filter, and values h0 to h7, as coefficients of a high pass filter, are stored in advance. In this example, an example of selecting one out of 12 types of wavelet transform candidates shown in FIG. 5 will be described.

Now description continues referred to FIG. 3. An evaluation circuit 304 is a circuit which receives a wavelet coefficient string from the converting processor 109, and measures a degree of similarity of the impulse response and the mother wavelet. For the evaluation function to measure the degree of similarity, the absolute sum of wavelet coefficients greater than or equal to a predetermined threshold is used.

If the degree of similarity of the mother wavelet and the impulse response function is high, most of the impulse response waveforms can be represented by a few wavelet coefficients. In this case, a few wavelet coefficients having a great value tend to appear. In this case, signal components which are lost in the threshold processing in the output unit 110 decrease. As a result, distortion of the signal waveform due to noise elimination processing decreases, therefore performance to separate the signal components and the noise components is high.

If the degree of similarity is low, on the other hand, wavelets having various frequencies and time values must be superposed little by little in order to represent the impulse response waveform. In this case, many small wavelet coefficients tend to appear. Then signal components which are lost in the threshold processing in the output unit 110 increase. As a result, distortion of the signal waveform due to noise elimination processing increases, therefore performance to separate the signal components and the noise components is low.

Hence in this example, the absolute sum of wavelet coefficients greater than or equal to a predetermined threshold is used in order to select, with priority, a mother wavelet which generates large wavelet coefficient values.

A filter selection circuit 305 in FIG. 3 is a circuit which compares a dispersion of values of previously attempted wavelet transform results, selects a filter coefficient number to be attempted next, and sends the filter coefficient number to the controller circuit 301. The controller circuit 301 calculates a filter coefficient memory address corresponding to the filter coefficient number received from the filter selection circuit 305, reads the filter coefficient from the filter coefficient memory 303, and sends the filter coefficient to the converting processor 109 along with the probe characteristic information.

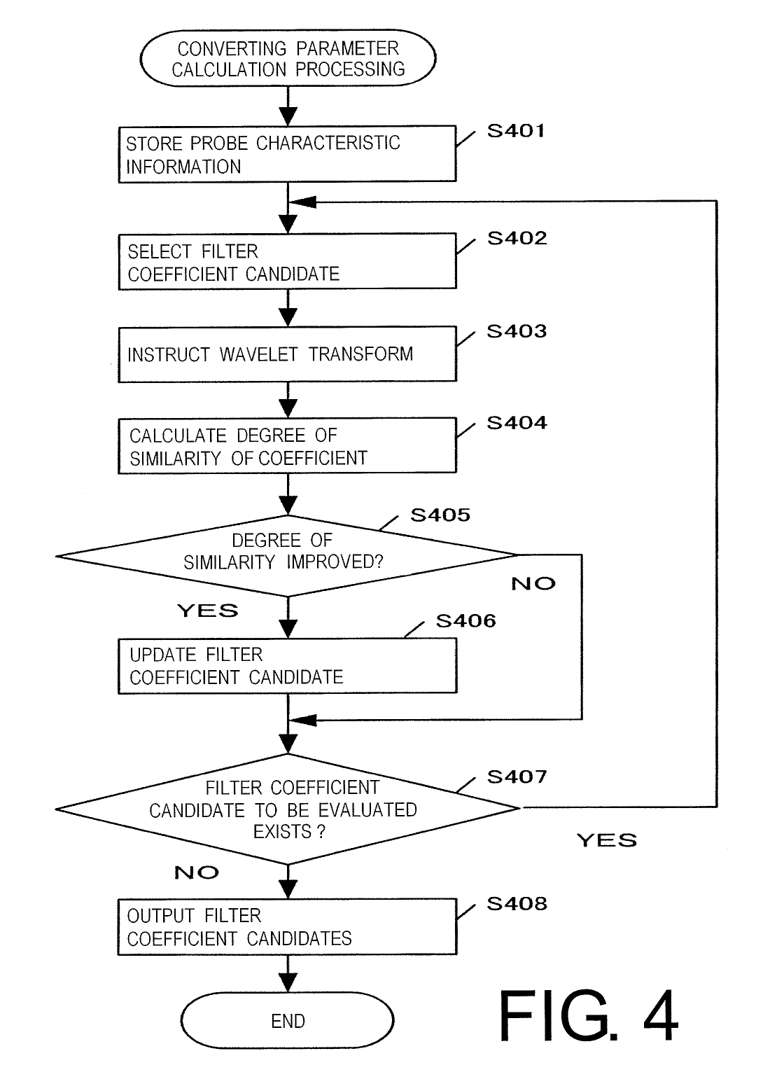

FIG. 4 shows a processing flow of the converting parameter calculator.

In step S401, the controller circuit 301 stores the impulse response waveform data in the characteristic information memory 302 as the probe characteristic information.

In step S402, the filter selection circuit 305 selects one of the plurality of filter coefficients stored in the filter coefficient memory 303, and sends the number of a corresponding filter coefficient to the controller circuit. In this example, the wavelet Daubechies4 in No. 0 is selected first.

In step S403, the controller circuit reads the filter coefficient selected in step S402 from the filter coefficient memory 303, and the impulse response from the characteristic information memory 302 as the probe characteristic information respectively, sends them to the converting processor 109, and instructs wavelet transform.

In step S404, the evaluation circuit 304 receives the processing result from the converting processor 109, and determines the degree of similarity between the impulse response and the wavelet.

In step S405, the filter selection circuit 305 determines whether the degree of similarity has improved compared with the degree of similarity evaluated in the past. If this is the first evaluation or if the degree of similarity has improved, processing advances to step S406, and updates the filter coefficient candidate number held in the register inside the filter selection circuit 305 to the number of the filter coefficient evaluated this time. If the determination result is NO, processing advances directly to step S407.

In step S407, it is determined whether there are filter coefficient candidates which have not been evaluated by the filter selection circuit 305. If the filter coefficient candidates remain, processing advances to step S402. In this example, 10 types of wavelets No. 1 to No. 11 remain, so processing advances to step S402 again.

In the second step S402, the wavelet Symlet4 in No. 1 is selected, and the same processing is repeated. If evaluation of all the filter coefficients in NO. 1 to No. 11 is over and filter coefficient candidates no longer remain, processing advances to step S408.

In step S408, the filter coefficients corresponding to the filter coefficient candidate numbers held in the register inside the filter selection circuit 305 are output to the converting processor 109.

In this example, a case of evaluating the types of wavelets sequentially from No. 0 to No. 11 was described, but the present invention is not actually limited to this method. It is possible to select a filter coefficient not by evaluating all the candidates, but by narrowing down the wavelets to be evaluated based on the degree of similarity determination result in the past. For example, if the degree of similarity of Daubechies4 is low in step S405, Symlet4 or the like, which are relatively similar to Daubechies4 can be skipped so as to decrease a number of times of evaluation.

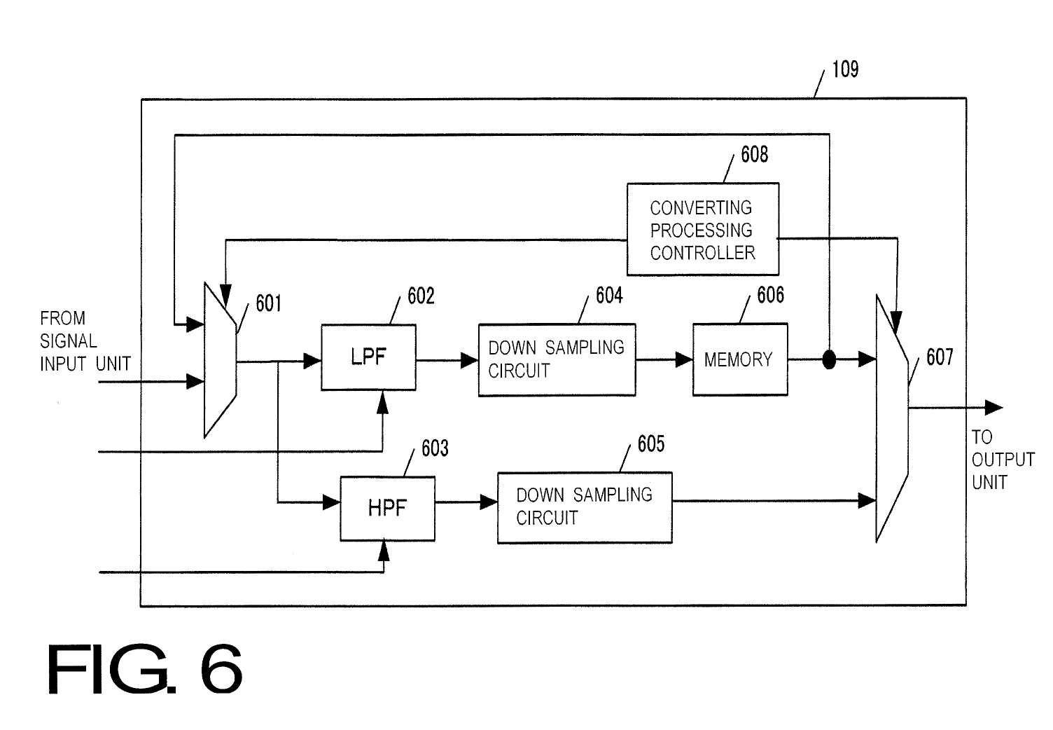

FIG. 6 shows an internal circuit diagram of the converting processor 109. A selection circuit 601 is an input selection circuit which selects either an input signal from the signal processor 106, or an output of a memory 606 according to an input selection signal from a converting processing controller 608.

An LPF 602 is a circuit for applying a low pass filter on a signal selected by the input selection circuit 601. In the low pass filter processing, a sum of product operation is executed for the filter coefficients g0, g1, . . . , gn (n is a natural number) which are input from the converting parameter calculator 108 and an input signal sample.

An HPF 603 is a circuit for applying a high pass filter on a signal selected by the input selection circuit 601. In the high pass filter processing, a sum of product operation is executed for the filter coefficients h0, h1, . . . , hn (n is a natural number) which are input from the converting parameter calculator 108 and an input signal sample.

A down sampling circuit 604 is a circuit which skips an output signal of the low pass filter 602 every other sample. A down sampling circuit 605 is a circuit which skips an output signal of the high pass filter 603 every other sample. A memory 606 is a memory which temporarily holds the output of the down sampling circuit 604.

An output selection circuit 607 is a circuit which selects either the output of the memory 606 or the output of the down sampling circuit 605 according to the output selection signal from the converting processing controller 608, and outputs the selected output to the output unit 110. The converting processing controller 608 is a circuit which specifies which signal the input selection circuit 601 and the output selection circuit 607 will select.

It is assumed that a number of samples of the input signal is the Nth power of 2. It is also assumed that M is a number of levels to be the object of noise elimination in the wavelet transform, and is a predetermined value less than or equal to N.

Until all input signals are input, the converting processing controller 608 selects an input selection signal, so that the input selection unit 601 selects an input signal from the signal processor 106, and then selects a signal from the memory 606. Until 2^{N}-2^{N-M} number of samples are output from the beginning, the converting processing controller 608 outputs an input selection signal so that the output selection unit 607 selects a signal from the down sample circuit 605. After the 2^{N}-2^{N-M} number of samples are output, the converting processing controller 608 outputs the input selection signal, so as to select a signal from the memory 606.

In this example, for the method of determining the degree of similarity, the evaluation function to compare the wavelet coefficient string of the impulse response waveform of the probe with a threshold, and determine the absolute sum is used, but the method of determining the degree of similarity is not limited to the method of this example. For example, dispersion of the wavelet coefficient string may be calculated so as to determine that one with less dispersion has a higher degree of similarity. A differential absolute sum with a mother wavelet may be directly determined for the impulse response waveform of the probe, so as to determine that one with less differential absolute sum has a higher degree of similarity.

In this example, noise is eliminated from the data after a wavelet transform, and all the coefficients are output to the outside, but a number of 0s which continue may be output instead of outputting the coefficients of 0. In this case, the output data transfer amount can be further decreased, and transfer time can be decreased.

In the present example, an apparatus configuration where noise is eliminated from data after a wavelet transform then data is output to the external personal computer, was described, but an imaging unit and display for displaying an image may be further included in the apparatus so that the measured data is displayed as an image.

In this example, Daubechies, Symlet and Coiflet wavelets were described as wavelet transform candidates, but the types of wavelet transforms are not limited to these. The Spline wavelet, for example, may be used.

As described above, according to Example 1, most appropriate wavelet transforms for the impulse response of the probe can be selected. Thereby the signal components and the noise components can be nicely separated, and the signal components which are lost by noise elimination can be decreased. As a result, the accuracy of noise elimination can be improved.

### Example 2

Now Example 2 will be described. The difference of Example 2 from the above mentioned Example 1 is that a probe ID number is input as the probe characteristic information on the probe.

In the block configuration in FIG. 1, operations of the measuring object 102, light source 103, probe 104, signal processor 106, converting processor 109, output unit 110, stationary plate 111 and stationary plate 112 are the same as Example 1, therefore description thereof is omitted.

The differences from Example 1 are as follows: a method of the controller 105 controlling operation timing of each portion; the probe information input unit 107 inputting a probe ID number as the characteristic information of the probe; and a method of the converting parameter calculator 108 calculating converting parameters.

The difference of the processing flow executed by the controller 105, compared with Example 1, will be described with reference to FIG. 2.

In step S201, the probe information input unit 107 inputs the probe characteristic information to the converting parameter calculating unit 108. In the case of Example 2, a probe ID number, which is different depending on the type of the probe, is input.

In step S202, the converting parameter calculator 108 selects a filter coefficient corresponding to the mother wavelet used in the converting processor 109, as a converting parameter. In Example 2, a filter coefficient corresponding to the probe ID number is selected out of the mother wavelets, which are prepared in advance. The correspondence of a probe ID number and a filter coefficient number is stored in the converting parameter calculator 108 in advance.

Description on the processings in step S203 and later, which is the same as Example 1, is omitted.

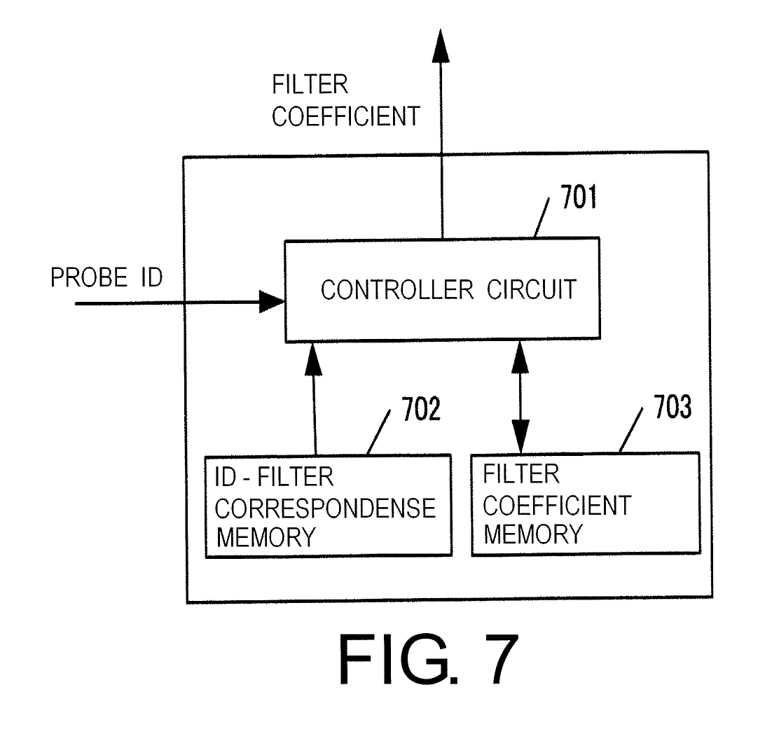

The method of selecting a filter coefficient in step S202 will be described. FIG. 7 shows an internal configuration of the converting parameter calculator 108 according to Example 2. A controller circuit 701 is a circuit which accesses the internal memory and transfers data to the converting processor 109. An ID-filter correspondence memory 702 is a memory which holds the correspondence of a probe ID number and a filter number to be selected. A filter coefficient memory 703 is a memory which holds filter coefficients corresponding to various wavelets. Description of the filter coefficient memory 703, which is the same as Example 1, is omitted.

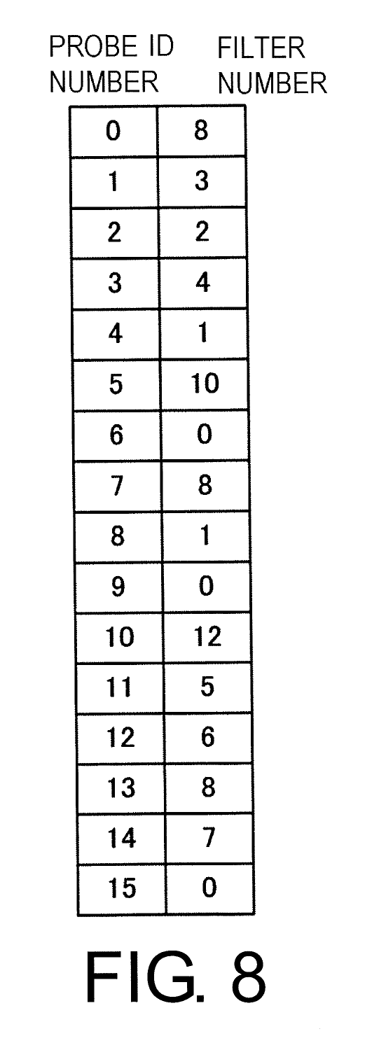

FIG. 8 shows an example of correspondence of probe ID numbers and filter numbers held in the ID-filter correspondence memory 702.

If a probe ID number is input, the controller circuit 701 reads a corresponding filter number referring to the ID-filter correspondence memory 702. For example, if 0 is input as the probe ID number, 8 is read as the filter number. Then the controller circuit 701 reads the corresponding filter coefficients from the filter coefficient memory 703, and sends them to the converting processor 109. With reference to the filter coefficient memory in FIG. 5, the filter coefficients of the Coiflet8 wavelet are selected and sent if the filter number is 8.

If the probe is changed to No. 1 next, 1 is input to the probe ID number. Then the controller 701 reads the filter number 3 referring to the ID-filter correspondence memory 702. Then the controller circuit 701 reads the filter coefficients of the Doubechies6 wavelet from the filter coefficient memory, and sends them to the converting processor 109. In this way, if a probe to be used is known and the correspondence with filter coefficients can be stored in advance, optimum filter coefficient of wavelet transform can be selected in a short time.

### Example 3

Now Example 3 will be described. The difference of Example 3 from Example 1 is that the probe characteristic information is not input from the outside, but is calculated within the apparatus.

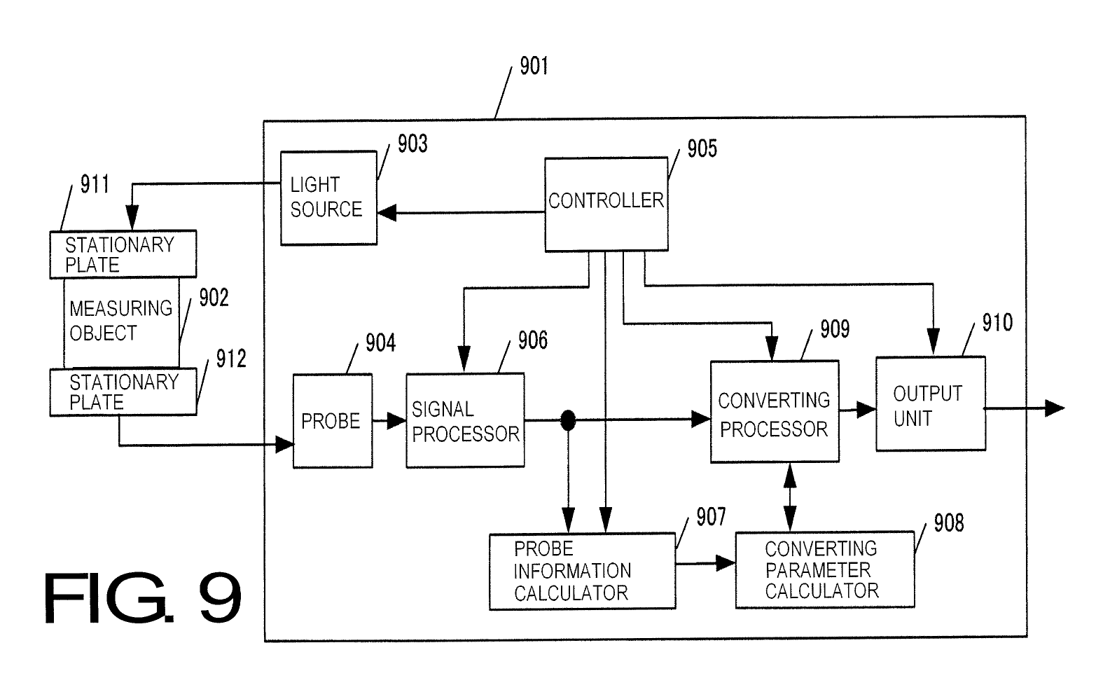

FIG. 9 is a block diagram depicting a biological information processing apparatus 901 of Example 3. Description on a measuring object 902, light source 903, probe 904, signal processor 906, converting parameter calculator 908, converting processor 909, output unit 910 and stationary plates 911 and 912, which is the same as Example 1, is omitted.

A controller 905 is a controller which controls operation timing of each portion. A difference from the controller of Example 1 is that the light source 903 and the probe information calculator 907 are controlled before measurement, and the probe characteristic information is calculated internally. In other words, in the case of Example 1, the probe characteristic information is input from the outside in step S201 in FIG. 2, but in this example, the probe characteristic information is calculated internally.

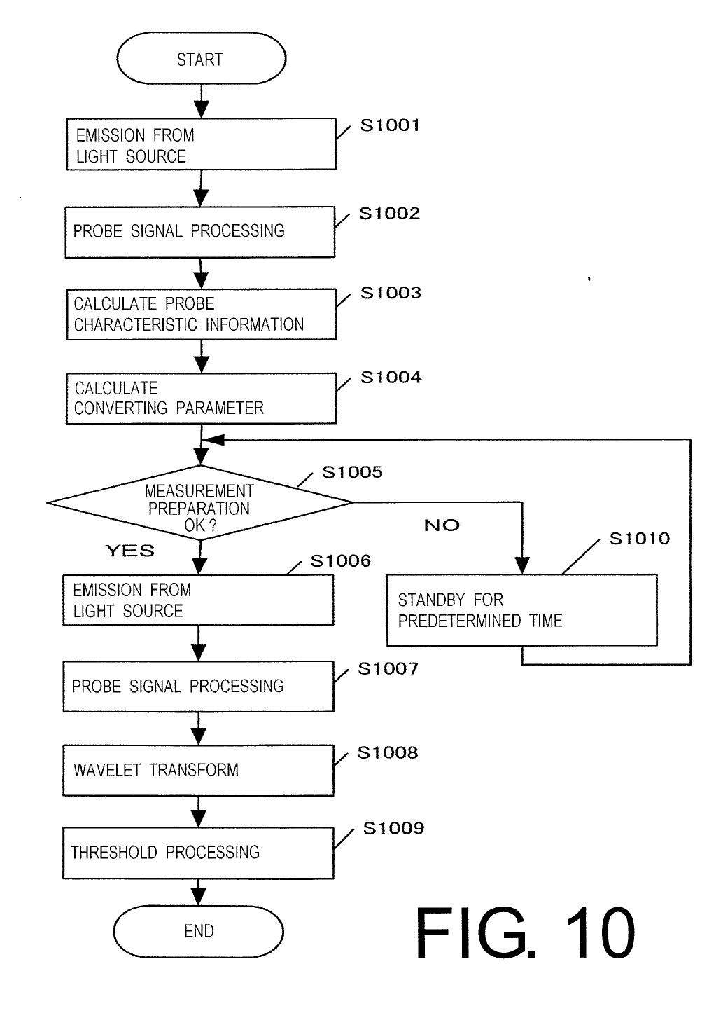

FIG. 10 shows a general processing flow of this example.

In step S1001, the controller 905 sends an instruction to the light source 903 to irradiate the pulse laser beam, before securing the measuring object 902 in front of the probe 904 and the light source 903. When the pulse laser beam is irradiated onto the surface of the probe, a photoacoustic wave is generated for a very short time, and is converted into an electric signal by the probe 904.

In step S1002, the signal processor 906 amplifies and digitizes the electric signals.

In step S1003, the probe information calculator 907 calculates the characteristic information of the probe. For this, the probe information calculator 907 extracts signals for a predetermined time, out of the signals which were input in step S1002, and generates an impulse response waveform by normalization, and sends them to the converting parameter calculator 908.

The flow in step S1004 and later is the same as the flow in step S202 and later of Example 1 shown in FIG. 2. In other words, a filter coefficient used for the wavelet transforms is selected based on the impulse response waveform obtained in step S1003, and used for separating the signal components and the noise components. Therefore description hereafter is omitted.

According to this example, the characteristic information of the probe can be obtained by measuring the impulse response waveform before measuring the object, without inputting the characteristic information externally. Therefore even if a probe of which characteristic is unknown is connected, characteristic information can be internally calculated, and an optimum wavelet transform can be performed using this information. As a result, the signal components and the noise components can be nicely separated, and the signal components which are lost by noise elimination can be decreased.

For the means of obtaining the impulse response of the probe, a method of entering the pulse laser beam directly into the probe was shown in this example, but the means of obtaining the impulse response is not limited to this. For example, a micro-light absorber may be provided on the stationary plate 111, so that the pulse laser beam is irradiated onto this light absorber, and an impulse response waveform is measured using the emitted photoacoustic wave.

In this example, the characteristic information of the probe was described using the impulse response, but the characteristic information of the probe is not limited to this. For example, the probe ID number may be used as the characteristic information of the probe, with providing a means of communicating with the probe, so that the probe ID number can be detected inside the apparatus at the start of the measurement.

### Example 4

Now Example 4 will be described. The difference of Example 4 from the above examples is that a biological information processing apparatus, not based on photoacoustic tomography but on ultrasonic echo technology, is used.

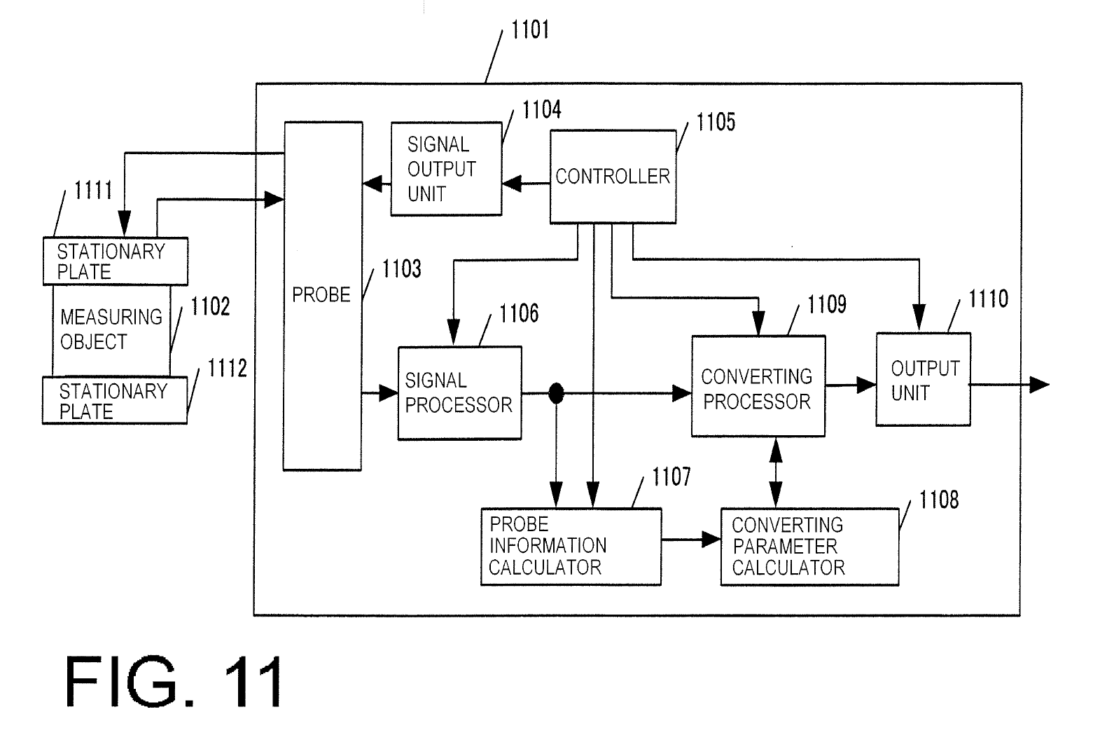

FIG. 11 is a block diagram depicting a biological information processing apparatus 1101 of Example 4. Operation of a measuring object 1102, signal processing unit 1106, converting parameter calculator 1108, converting processor 1109, output unit 1110 and stationary plates 1111 and 1112, which is the same as Example 1, therefore description thereof is omitted.

A signal output unit 1104 is an electric circuit which outputs (transmits) the pulse signals to the probe. The probe 1103 is a transducer which converts a pulse signal into an ultrasonic wave, and transmits it to the measuring object 1102, and also receives the ultrasonic wave reflected from the measuring object 1102, and converts it into an electric signal. In this example, the probe 1103 therefore corresponds to the generator.

A controller 1105 is a control circuit which controls operation timing of each portion. A difference from the controllers of the above example is controlling the signal output unit 1104 and the probe information calculator 1107 before measurement, instead of the light source. In the biological information processing apparatus using an ultrasonic echo, transmission pulses having various waveforms can be generated by controlling the signal output unit. The transmission waveform parameters to specify the waveform of the transmission pulse, are frequency, amplitude and type of waveforms, such as a rectangular wave or sine wave. Depending on the transmission waveform a profile of the signal waveform to be input to the signal processor 1106 changes, and the type of wavelet transform to be used also changes. Therefore optimum converting parameter is calculated depending on the transmission waveform parameter. In this example, frequency is described as an example of a transmission waveform parameter.

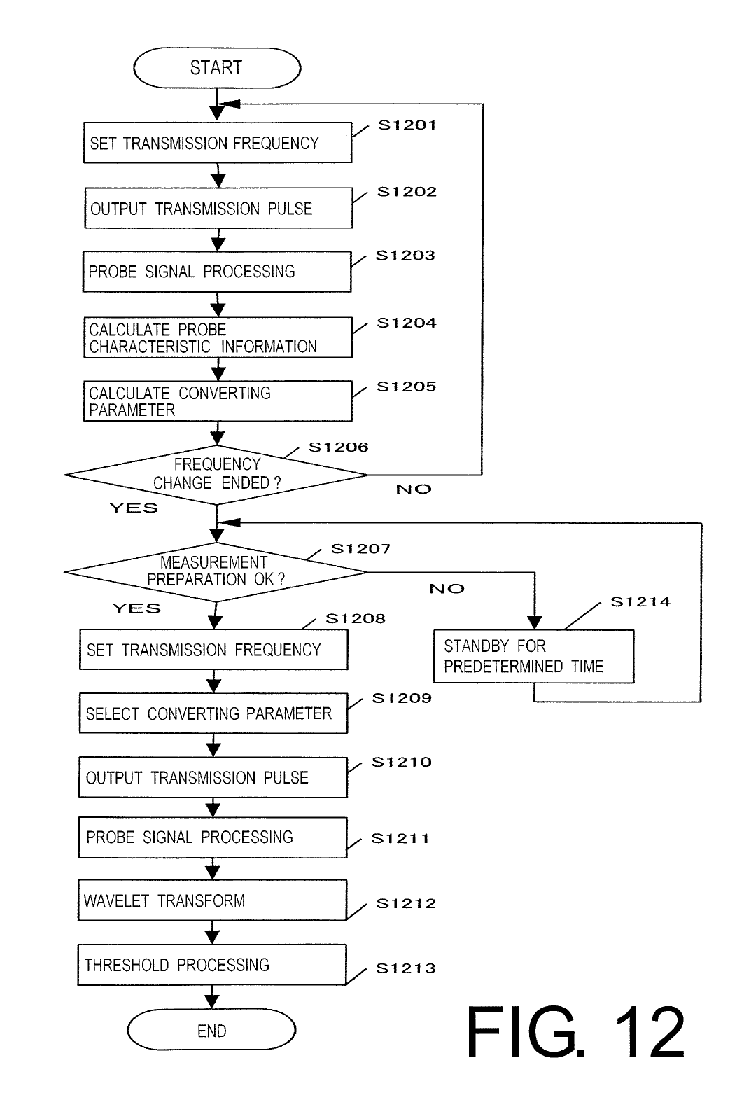

FIG. 12 shows a general processing flow of this example.

In step S1201, the controller 1105 selects one of the predetermined transmission waveform parameters in a state before setting the measuring object in the stationary plates.

In step S1202, the controller 1105 instructs the signal output unit 1104 to transmit a signal of the transmission waveform parameter selected in step S1201 to the probe 1103. Then the transmission signal is converted into an ultrasonic wave and output by the probe 1103. The ultrasonic wave which was output is partially reflected on the surface of the stationary plate 1112, and is input to the probe 1103, and is converted into an electric signal.

In step S1203, the signal processor 1106 amplifies and digitizes the electric signal. The signal processor 1106 performs a delay-and-sum operation, so as to align phases of the signals among a plurality of elements of the probe.

In step S1204, the probe information calculator 1107 calculates the characteristic information of the probe. For this, the probe information calculator 1107 extracts signals for a predetermined time, out of the signals which are input in step S1203, generates an impulse response waveform by normalization, and transmits the impulse response waveform to the converting parameter calculator 1108.

In step S1205, the converting parameter calculator 1108 calculates a converting parameter in the same manner as the above examples, and stores it corresponding with the transmission waveform parameter selected in step S1201.

In step S1206, the controller 1105 determines whether there are other transmission waveform parameters supported by the apparatus. If calculation of the converting parameter ended for all the transmission waveform parameters, processing advances to step S1207. If transmission waveform parameters for which the converting parameter is not calculated remains, processing advances to step S1201, and processing continues.

In step S1207, it is checked whether measurement preparation is ready. If the measuring object 1102 is secure in front of the probe 1103 by the stationary plates 1111 and 1112, it is regarded that the measurement preparation is ready, and processing advances to step S1208. If the measuring object is not secured, processing advances to step S1214, and returns to step S1207 after standing by for a predetermined time.

In step S1208, a transmission waveform parameter of the ultrasonic wave to be irradiated onto the measuring target is set. In this example, frequency is selected according to the observation depth in the measuring object. If the depth is deep, a low frequency is selected, and if the depth is shallow, a high frequency is selected. This change of frequency may be executed by a user's instruction, or may be automatically executed in the apparatus.

In step S1209, the controller 1105 selects a converting parameter corresponding to the transmission waveform parameter selected in step S1208, out of the converting parameters stored in step S1205.

In step S1210, the controller 1105 instructs the signal output unit 1104 to output a signal of the transmission waveform parameter selected in step S1208 to the probe 1103. Then the pulse signal is converted into an ultrasonic wave, and is output by the probe 1103.

In step S1211, the probe 1103 converts the ultrasonic wave reflected from the measuring object into an electric signal. The signal processor 1106 amplifies and digitizes the electric signal, and performs delay-and-sum operation so as to align phases of the signals among a plurality of elements of the probe.

In step S1212, the converting processor 1109 performs wavelet transform processing on the signal digitized in step S1211 using the filter coefficient calculated in step S1209, and calculates the wavelet coefficient string.

In step S1213, the output unit 1110 changes the coefficients less than or equal to a predetermined threshold to 0, and outputs them.

In step S1209, a function close to the impulse response is selected as a mother wavelet, and the wavelet transform in step S1212 is performed using the corresponding filter functions. Thereby irregular noise components and signal components generated from the ultrasonic wave can be accurately separated. In other words, the signal components appear in a few coefficients as large values, and irregular noise components are distributed in many coefficients as small values. By the processing in step S1213, noise components are eliminated, and only signal components generated from the ultrasonic wave are output.

According to this example, an impulse response waveform can be measured, and characteristic information can be obtained before measuring the object for an ultrasonic diagnostic apparatus as well. Therefore even if a probe of which characteristics are unknown is connected or even if a transmission frequency is changed, the characteristic information can be internally calculated, and optimum wavelet transform can be performed using this characteristic information, and signal deterioration upon eliminating noise can be decreased. As a result, noise elimination accuracy improves.

In this example, a configuration where a delay-and-sum operation is performed by the signal processor 1106 and wavelet transform is then executed was described, but the sequence of processing is not limited to this. For example, the output unit 1110 may perform the delay-and-sum operation after wavelet transform is executed.

In this example, frequency was used to describe the transmission waveform parameter, but the transmission waveform parameter is not limited to this. For example, a signal amplitude or a type of waveform, such as a rectangular wave or sine wave, may be used as a transmission waveform parameter.

The biological information processing apparatus of each of the above examples may be regarded as a biological information processing program to have an information processing apparatus execute the processing of each block constituting the apparatus. It can also be regarded as a biological information processing method for executing the processing of each block constituting the apparatus.

While the present invention has been described with reference to exemplary embodiments, it is to be understood that the invention is not limited to the disclosed exemplary embodiments. The scope of the following claims is to be accorded the broadest interpretation so as to encompass all such modifications and equivalent structures and functions.

This application claims the benefit of Japanese Patent Application No. 2010-060884, filed on Mar. 17, 2010, which is hereby incorporated by reference herein in its entirety.

What is claimed is:

1. A subject information processing apparatus, comprising:
an acoustic wave generator which generates an acoustic wave from a subject;
a probe which receives the acoustic wave generated from the subject, and converts the received acoustic wave into an electric signal;
a converting processor which determines a wavelet coefficient string by performing a wavelet transform on the electric signal; and
a threshold processor which eliminates wavelet coefficients smaller than a predetermined threshold, out of the wavelet coefficient string, wherein
the converting processor selects a coefficient string corresponding to a mother wavelet of which degree of similarity with an impulse response waveform of the probe is highest, out of coefficient strings corresponding to a plurality of mother wavelets stored in advance, and performs the wavelet transform.

2. The subject information processing apparatus according to claim 1, wherein
the converting processor determines the degree of similarity based on a result of performing the wavelet transform using each of the plurality of mother wavelets on the impulse response waveform of the probe.

3. The subject information processing apparatus according to claim 1, wherein
the acoustic wave generator generates the impulse response waveform in the probe before generating the acoustic wave in the subject, and
the converting processor selects a coefficient string corresponding to a mother wavelet using the generated impulse response waveform.

4. The subject information processing apparatus according to claim 1, further comprising:
a memory which stores a type of the mother wavelet of which degree of similarity with the impulse response waveform of the probe is highest for each type of the probe; and
the converting processor selects a coefficient string corresponding to the mother wavelet corresponding to the probe referring to the memory.

5. The subject information processing apparatus according to claim 1, wherein
the acoustic wave generator is a light source which irradiates light onto the subject, and
the acoustic wave is a photoacoustic wave emitted from the subject onto which the light is irradiated from the light source.

6. The subject information processing apparatus according to claim 1, wherein
the acoustic wave generator is the probe which irradiates an ultrasonic wave onto the subject, and
the acoustic wave is the ultrasonic wave reflected by the subject.

7. A subject information processing method, comprising:
a step of an information processing apparatus converting an acoustic wave, which is generated from a subject and received by a probe, into an electric signal;
a converting step of the information processing apparatus determining a wavelet coefficient string by performing a wavelet transform on the electric signal; and
a step of the information processing apparatus eliminating wavelet coefficients smaller than a predetermined threshold out of the wavelet coefficient string, wherein
in the converting step, a coefficient string corresponding to a mother wavelet of which degree of similarity with an impulse response waveform of the probe is highest is selected out of coefficient strings corresponding to a plurality of mother wavelets stored in advance, and the wavelet transform is performed.

8. A subject information processing program causing an information processing apparatus to execute:
a converting step of determining a wavelet coefficient string by performing a wavelet transform on an electric signal converted from an acoustic wave which is generated from a subject and received by a probe; and
a step of eliminating wavelet coefficients smaller than a predetermined threshold out of the wavelet coefficient string, wherein
in the converting step, a coefficient string corresponding to a mother wavelet of which degree of similarity with an impulse response waveform of the probe is highest is selected out of coefficient strings corresponding to a plurality of mother wavelets stored in advance, and the wavelet transform is performed.
